(19) United States
(12) Patent Application Publication
(10) Pub. No.: US 2012/0109771 A1
(43) Pub. Date: May 3, 2012

(54) Application Name Marketplace

(75) Inventor: Kamran Rajabi Zargahi, Seattle, WA (US)

(73) Assignee: MICROSOFT CORPORATION, Redmond, WA (US)

(21) Appl. No.: 12/917,196

(22) Filed: Nov. 1, 2010

(51) Int. Cl. G06Q 30/00

(52) U.S. Cl. 705/26.3; 705/26.1; 705/27.1

(57) ABSTRACT

Application name marketplace techniques are described. In one or more implementations, a service provide implemented by one or more computing devices identifies one or more terms for use in naming applications to be available for purchase via a network. The one or more terms are exposed by the service as available for purchase of a right to use the one or more terms to name a respective application.

### BACKGROUND

With the proliferation of application availability via the Internet, users may be exposed to a multitude of applications that are available for purchase. For example, a user may access an application marketplace and choose from hundreds and even thousands of different applications that are available for download. Traditional techniques that were used to locate the applications, however, may be inefficient and time consuming to navigate when confronted with this multitude. Thus, the sheer number of applications that are available via the marketplace may make it difficult to locate a particular application of interest.

### SUMMARY

Application name marketplace techniques are described. In one or more implementations, a service provide implemented by one or more computing devices identifies one or more terms for use in naming applications to be available for purchase via a network. The one or more terms are exposed by the service as available for purchase of a right to use the one or more terms to name a respective application.

In one or more implementations, one or more terms are exposed as available for purchase for use in naming an application in an application marketplace, the application marketplace configured to provide an opportunity to download one or more of the applications from the service provider. An indication is received of an intent to purchase the right to use a particular term for use in the application marketplace.

In one or more implementations, a computing device outputs a user interface received via a network from a service provider, the user interface indicating availability of one or more terms for purchase for use in naming an application in an application marketplace, the application marketplace configured to provide an opportunity to download one or more said applications from the service provider. An indication is provided of an intent to purchase the right to use a particular term in the application marketplace.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of an environment that is operable to employ the techniques described herein.

FIG. 2 illustrates a system in an example implementation showing a service provider of FIG. 1 as providing a name marketplace and an application marketplace.

FIG. 3 is a flow diagram depicting a procedure in an example implementation in which terms for naming applications are exposed for purchase.

FIG. 4 is a flow diagram depicting a procedure in an example implementation in which a user interacts with a user interface to purchase a right to use a term to name an application in an application marketplace.

FIG. 5 is a flow diagram depicting a procedure in an example implementation in which revenue is collected for providing an opportunity to purchase a right to use a term for use in naming an application in an application marketplace.

### DETAILED DESCRIPTION

### Overview

As previously described, application marketplaces may include hundreds and even thousands of applications. Therefore, it may be difficult to locate a particular application of interest, making it a challenge for application developers to drive attention and traffic toward their applications.

An application name marketplace is described. In one or more implementations, the application name marketplace leverages application names to drive attention and traffic to particular applications. For example, in an application-based and post-website era, application marketplaces are slowly but surely replacing search-based actions because many of the actions that may be desired by a user are taken up via applications on mobile communication devices, e.g., smart phones, tablets, and so on. However, location of the applications in a marketplace may be difficult due to the multitude of applications that may be made available to the user.

Accordingly, a name marketplace may be provided. The name marketplace may be used to market rights to purchase terms for use in naming an application. Therefore, applications that are provided via an application marketplace may be named using one or more of the terms purchased via the name marketplace. Thus, the names of the applications may be used as an intention-engine and monetized by the name marketplace, further discussion of which may be found in relation to the following figures.

In the following discussion, a variety of example implementations of a mobile communication device (e.g., a wireless phone) are described. Additionally, a variety of different functionality that may be employed by the mobile communications device is described for each example, which may be implemented in that example as well as in other described examples. Accordingly, example implementations are illustrated of a few of a variety of contemplated implementations. Further, although a mobile communications device having one or more modules that are configured to provide telephonic functionality are described, a variety of other mobile devices are also contemplated, such as personal digital assistants, mobile music players, dedicated messaging devices, portable game devices, netbooks, and so on.

### Example Implementations

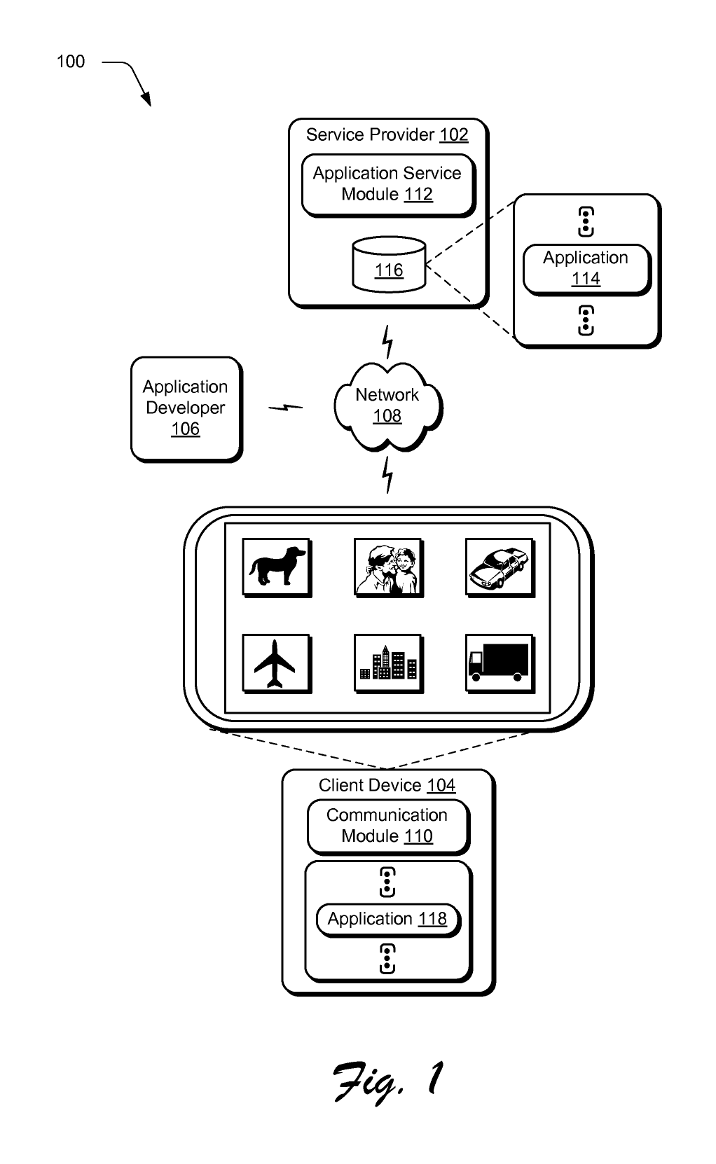

FIG. 1 is an illustration of an example implementation of an environment 100 that is operable to employ the techniques described herein. The environment includes a service provider 102, a client device 104, and an application developer 106 that are illustrated as communicatively coupled, one to another, via a network 108. The service provider 102, the client device 104, and the application developer 106 may be implemented by a variety of different computing devices. For example, a computing device may be configured as a computer that is capable of communicating over a network, such as a desktop computer, a mobile station, an entertainment appliance, a mobile communication device as illustrated for the client device 104, a set-top box communicatively coupled to a display device, a wireless phone, a game console, and so forth.

Thus, computing devices may range from full resource devices with substantial memory and processor resources (e.g., personal computers, game consoles) to low-resource devices with limited memory and/or processing resources (e.g., traditional set-top boxes, hand-held game consoles). Additionally, a computing device may be formed from multiple devices (e.g., servers in a server farm) and thus is not limited to implementation to a single traditional desktop PC.

A computing device may also include an entity (e.g., software) that causes hardware of the computing device to perform operations, e.g., configures processors, functional blocks, and so on. For example, the computing device 102 may include a computer-readable medium that may be configured to maintain instructions that cause the computing device, and more particularly hardware of the computing device to perform operations. Thus, the instructions function to configure the hardware to perform the operations and in this way result in transformation of the hardware to perform the operations. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via the network 108. The computer-readable medium may also be configured as a computer-readable storage medium and thus is not a signal bearing medium. Examples of a computer-readable storage medium include a random-access memory (RAM), read-only memory (ROM), optical discs, flash memory, hard disk memory, and other memory devices that may use magnetic, optical, and other techniques to store instructions and other data.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The client device 104 is further illustrated as including a communication module 110. The communication module 110 is representative of functionality of the client device 104 to communicate via the network 108. For example, the communication module 110 may include telephone functionality to make and receive telephone calls, such as by employing a telephone module to communicate via a plain old telephone service (POTS), wireless network (e.g., cellular and/or Wi-Fi), and so on.

The communication module 110 may also include a variety of other functionality, such as to capture content, form short message service (SMS) text messages, multimedia messaging service (MMS) messages, emails, status updates to be communicated via a social network service or micro-blog, and so on. For instance, the communication module 110 may also support browser functionality to browse the network 108 to interact with the service provider 102.

The service provide 102 is illustrated as including an application service module 112 that is representative of functionality to the service provider 102 to expose one or more applications 114 for download from storage 116. For example, the application service module 112 may store applications 114 received from an application developer 106. Collection of applications 114 from a plurality of such application developers 106 may thus be used to support a marketplace in which one or more client devices 104 may navigate to the service provider 102 via the network 108 to locate an application 114 of interest. The application 114 may then be downloaded via the network 108 (e.g., in response to payment of a fee or for free) to the client device 104 and stored, as illustrated by application 118. In this way, the service provider 102 may work as an intermediary to connect application developers 106 with users of client devices 104, further discussion of which may be found in relation to the following figure.

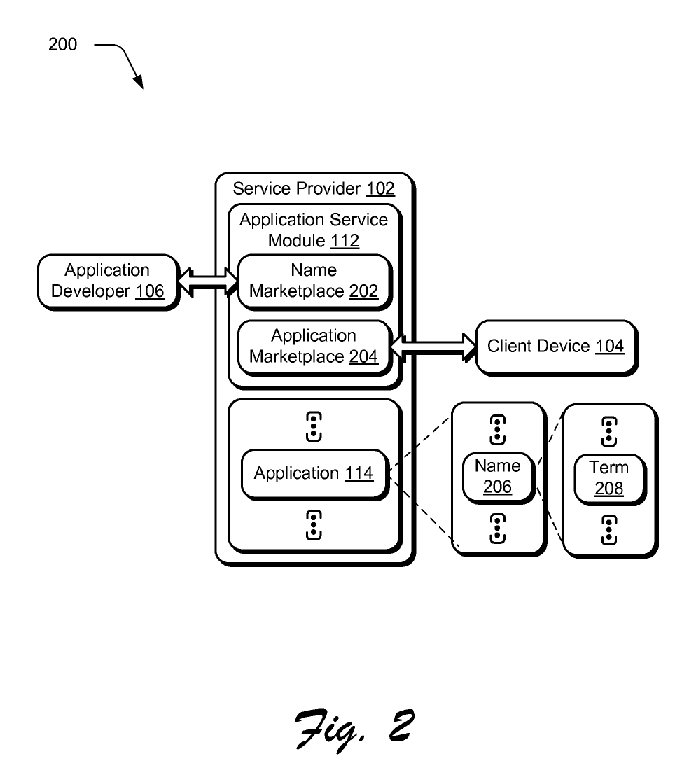

FIG. 2 illustrates a system 200 in an example implementation showing the service provider 102 as providing a name marketplace 202 and an application marketplace 204. The application marketplace 204 implemented by the application service module 112 may be used to expose a variety of different applications 114 for purchase by a client device 104. To identify the applications 114 in the application marketplace 204, the application 114 may employ a name 206 formed using one or more terms 208. For example, an application “Ellie's Quick Drawing” includes multiple terms that may identify a variety of different characteristics of the application 114, such as a source (e.g., “Ellie”) and functionality (e.g., “Drawing”). A variety of other examples are also contemplated, such as names 260 made up of single terms 208.

Thus, the name 206 and the terms 208 included therein may serve a vehicle to identify intent on the part of a user of the client device 104 to locate desired functionality from the applications 114. In the beginning of the World Wide Web, for instance, uniform resource locators (URLs) played a central role in directing traffic to websites. Hence, marketplaces were created that provided an environment for bidding on and assigning ownership of particular URLs.

As the World Wide Web evolved into a form that involved increased reliance on search, however, user intent was often manifested in the form of “keywords” that were used by search engines. In this model, search engines acted primarily for information gathering and structuring. Consequently, keywords functioned as a primary indicator for user intention and thus marketplaces formed for bidding and “owning” keywords utilized within search services.

With the arrival of the application marketplace 204, search for information is more vertical, local, and thus exhibits a greater amount of “intent” from a user's perspective as opposed to the instances described above. When a user launches an application dedicated to locating movie times, for instance, the user is looking for local information about movies. Thus, in this model the use of proactive information gathering and structuring as performed by search engines may lessen as users are able to locate desired functionality from specific designed applications 114. However, a challenge then remains as to how to get users of the client device 104 to discover the applications 114 within the application marketplace 204, i.e., how do the users express their intent in this scenario. As previously described, for instance, with hundreds and even thousands of applications 114 that may be available via the application marketplace 204, it may be difficult for application developers 106 to connect with consumers (e.g., the users of the client device 104).

Search techniques and categorization of the applications 114 may still be used by the application service module 112 to locate applications 114 as before. In addition, the application service module 112 may leverage names 206 of the applications 114 themselves as a vehicle to determine intent and thus may function as an “intention engine.” Because the name 206 of the application 114 may be used as expressed intent of a user, terms 208 used in the name may be monetized through a name marketplace 202.

The name marketplace 202, for instance, may permit use of particular terms 208 in names 206 of applications 114 in the application marketplace 204 of the service provider. Thus, the name marketplace 202 may allow for ownership and transition of application terms 208, which further can introduce a new revenue stream for the service provider 102. Additionally, the name marketplace 202 may reserve particular terms for purchase at higher prices than other such terms 208. Further, the application service module 112 may support techniques to determine availability of terms 208 with the name marketplace 202. Further discussion of these and other techniques may be found in relation to the following procedures.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

### Example Procedures

The following discussion describes user interface techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 and system 200 of FIGS. 1 and 2, respectively.

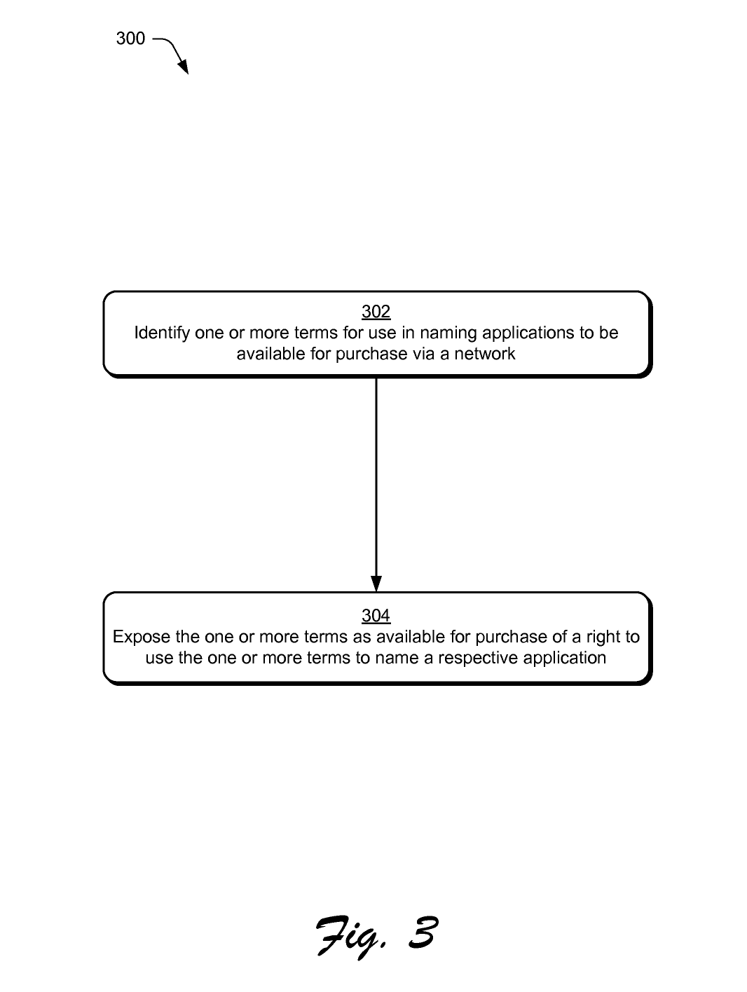

FIG. 3 depicts a procedure 300 in an example implementation in which terms for naming applications are exposed for purchase. One or more terms are identified for use in naming applications to be available for purchase via a network (block 302). This identification may be performed in a variety of ways. For example, the service provider 102 may reserve particular terms 208 for purchase, e.g., poker. A variety of other examples are also contemplated, such as to identify terms 208 that are descriptive of functionality of an application 114 as opposed to terms that are descriptive of a source of the application 114, receive an indication from user as desiring to purchase rights to use the terms, and so on.

One or more of the terms are exposed as available for purchase of a right to use the one or more terms to name a respective application (block 304). The purchase may be performed in a variety of ways. For example, the service provider 102 may set particular fees for particular terms. In this way, the service provider 102 may charge different amounts for different terms, such as more for reserved terms than other terms. In another example, an auction process may be used to bid on terms 208. An application developer 106, for instance, may interact with a user interface via the network 104 (e.g., via browser functionality employed by a computing device) to bid on terms 208.

Additionally, the name marketplace 202 may serve as an intermediary such that application developers 106 and others may buy and sell rights for use of particular terms 208 to be employed in names 206 of applications 114. For example, a user may have obtained rights to use a particular term 208 and sell that right to another user, e.g., the application developer 106, for use in naming an application 114. In this way, a user may interact with a name marketplace 202 to purchase a right to use a term 208 to name 206 an application 114, further discussion of which may be found in relation to the following figure.

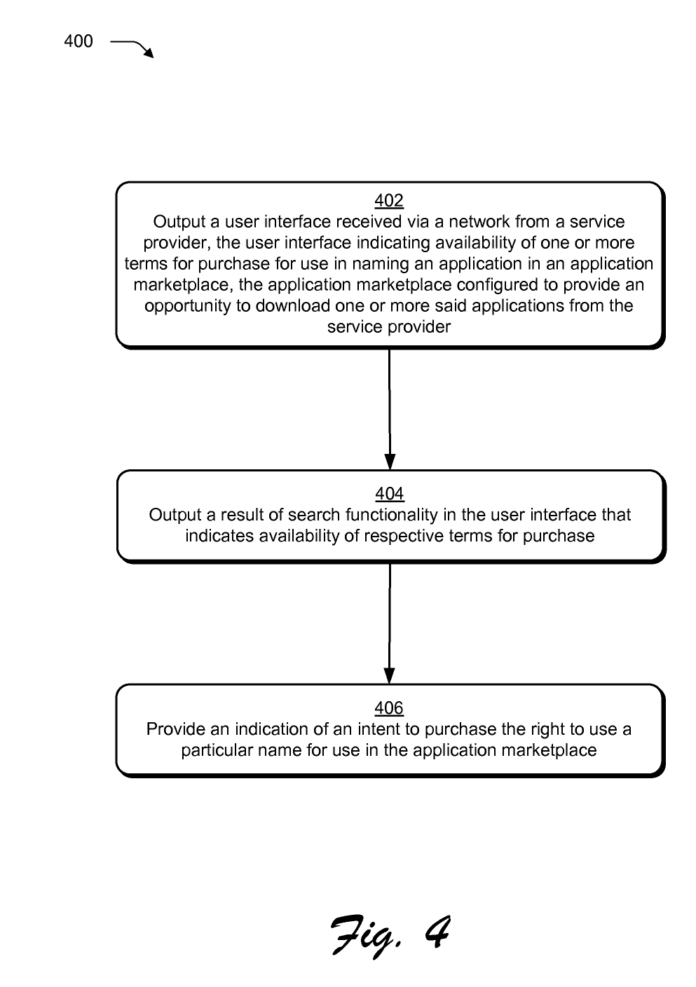

FIG. 4 depicts a procedure 400 in an example implementation in which a user interacts with a user interface to purchase a right to use a term to name an application in an application marketplace. A user interface received from a service provider is output, the user interface indicating availability of one or more terms for purchase for use in naming an application in an application marketplace, the application marketplace configured to provide an opportunity to download one or more of the applications from the service provider (block 402). The application developer 106, for instance, may navigate via the network 108 to the service provider 102 and receive a webpage that describe availability of terms 208. This availability may be expressed in a variety of ways, such as whether the term is currently being used, how the term 208 is currently being used (if at all), purchase price for a right to use the term 208, and so on.

The user interface may also be configured to output a result of search functionality that indicates availability of respective terms for purchase (block 404). The application service module 112, for instance, may employ functionality that allows a user (e.g., the application developer 106, a user of the client device 104, and so on) to search for terms 208. The result may include whether the terms are available for purchase, an amount to purchase a right to use the term 208 (e.g., for an amount of time), and so forth.

An indication may be provided of an intent to purchase the right to use a particular term for use in the application marketplace (block 406). Continuing with the previous example, the user may interact with the user interface and select a right to use one or more terms 208 in a name 206 of an application 114. An agreement may then be entered between the user (e.g., application developer 106) and the service provider 102 for this use. For example, the agreement may specify a monetary amount based on a number of instances in which the application 114 was downloaded, a price for a predefined amount of time, and so on.

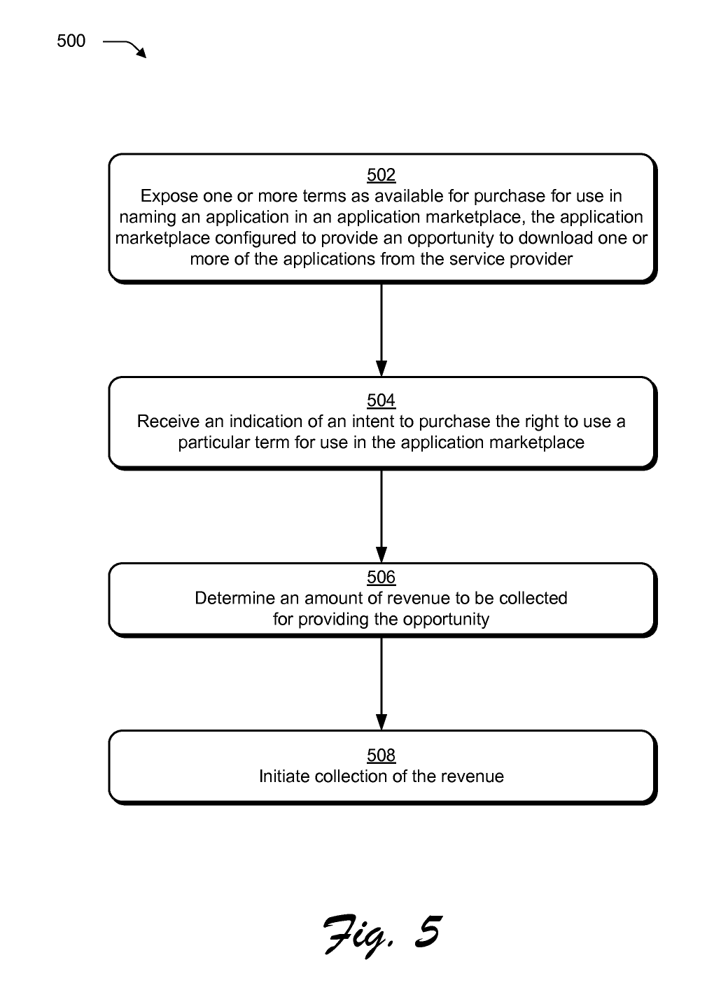

FIG. 5 depicts a procedure 500 in an example implementation in which revenue is collected for providing an opportunity to purchase a right to use a term to name an application in an application marketplace. One or more terms are exposed as available for purchase for use in naming an application in an application marketplace, the application marketplace configured to provide an opportunity to download one or more of the applications from the service provider (block 502). An indication is received of an intent to purchase the right to use a particular term in the application marketplace (block 504). As previously described, the name marketplace 202 may provide for transactions to transition rights to use terms 208 in names 206 of applications 114 that are available for download via the application marketplace 204.

A determination is made as to an amount of revenue to be collected for providing the opportunity (block 506). This determination may be based on a variety of factors, such as an amount of time the right to use the term 208 is valid, an amount of a winning bid in an auction, a fee charged by the service provider 102 to transfer the right between other parties, and so on. Collection of the revenue is initiated (block 508), such as to collect billing credentials, provide an invoice for the amount, and so on. Thus, an exchange-based marketplace may be implemented that allows for fair transition of terms 208 to be used as names 206 of applications 114.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices of a service provider, the method comprising:
identifying one or more terms for use in naming applications to be available for purchase via a network; and
exposing the one or more terms as available for purchase of a right to use the one or more terms to name a respective said application.

2. A method as described in claim 1, wherein the identifying is performed by the service provider to reserve the one or more terms.

3. A method as described in claim 1, wherein the identifying is performed by one or more users that access an application marketplace that also performs the exposing.

4. A method as described in claim 1, wherein the exposing is provided as a part of search functionality and indicates availability of respective said terms.

5. A method as described in claim 1, wherein the right is to use the one or more terms to name the respective said application for use in an application marketplace that provides the application for purchase.

6. A method as described in claim 1, wherein the one or more terms are available for purchase via the network using an auction.

7. A method as described in claim 1, wherein the one or more terms are available for purchase via the network for a set price.

8. A method as described in claim 7, wherein the price is set based on a number of purchases of the application via an application marketplace.

9. A method as described in claim 1, wherein one said name used to identify a respective said application in an application marketplace of the service provider is formed from a plurality of said terms.

10. A method as described in claim 9, wherein a price paid for respective said terms included in the one said name is different, one to another.

11. A method as described in claim 1, wherein the names used to identify respective said applications in an application marketplace of the service provider are unique, one to another.

12. A method implemented by one or more computing devices of a service provider, the method comprising:
exposing one or more terms as available for purchase for use in naming an application in an application marketplace, the application marketplace configured to provide an opportunity to download one or more said applications from the service provider; and
receiving an indication of an intent to purchase the right to use a particular said term for use in the application marketplace.

13. A method as described in claim 12, wherein the one or more terms are exposed for access via a network by a browser.

14. A method as described in claim 12, wherein at least one said term is available for purchase at an amount that is higher than another said term.

15. A method as described in claim 12, wherein the one or more terms are exposed for purchase via the network using an auction.

16. A method as described in claim 12, wherein one said name used to identify a respective said application in an application marketplace of the service provider is formed from a plurality of said terms.

17. A method as described in claim 12, wherein the exposing is provided as a part of search functionality and indicates availability of respective said terms.

18. A method implemented by a computing device, the method comprising:
outputting a user interface received via a network from a service provider, the user interface indicating availability of one or more terms for purchase for use in naming an application in an application marketplace, the application marketplace configured to provide an opportunity to download one or more said applications from the service provider; and
providing an indication of an intent to purchase the right to use a particular said term for use in the application marketplace.

19. A method as described in claim 18, wherein the user interface is configured to interact with an auction.

20. A method as described in claim 18, wherein at least one said term is available for purchase at an amount that is higher than an amount for another said term.
